(19) United States
(12) Patent Application Publication
(10) Pub. No.: US 2009/0087690 A1
(43) Pub. Date: Apr. 2, 2009

(54) MICROBIAL FUEL CELL WITH ANION EXCHANGE MEMBRANE AND SOLID OXIDE CATALYST

(76) Inventors: Gerardo Jose la O', Boston, MA (US); Joseph John Walish, Cambridge, MA (US); Ethan Jon Crumlin, Cambridge, MA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 12/238,996

(22) Filed: Sep. 26, 2008

Related U.S. Application Data
(60) Provisional application No. 60/995,482, filed on Sep. 27, 2007.

(51) Int. Cl. H01M 8/16

(52) U.S. Cl. 429/2

(57) ABSTRACT

A microbial fuel cell apparatus and system suitable for use for off-grid rural or remote power applications in developing countries, among others.

### RELATED APPLICATION

This application claims benefit of priority to Provisional U.S. Patent Application No. 60/995,482, filed Sep. 27, 2007, entitled MICROBIAL FUEL CELL WITH ANION EXCHANGE MEMBRANE AND SOLID OXIDE CATALYST; the aforementioned priority application being hereby incorporated by reference in its entirety.

### TECHNICAL FIELD

Embodiments described herein pertain to renewable fuel cells, and more particularly, to microbial fuel cells.

### BACKGROUND

A microbial fuel cell a device that converts chemical energy to electrical energy by the catalytic reaction of bacterial enzymes. A typical microbial fuel cell consists of anode and cathode chambers separated by a proton exchange membrane which allows protons to pass between the chambers.

In the anode chamber, in an electro-oxidation process, organic matter, such as glucose or cellulose is oxidized by the bacterial enzymes, generating electrons and protons. Electrons are transferred to the cathode chamber through an external electric coupling, and the protons are transferred to the cathode compartment through the proton exchange membrane. Electrons and protons are consumed in an electro-reduction process at the cathode compartment, where protons react with the electrons developed from the electro-oxidation process at the anode. Taken in total, the electro-oxidation and electro-reduction processes at the anode and cathode respectively create a potential difference whereby an electrical current may be driven through the external electrical coupling.

Typically a platinum catalyst has been used in conjunction with a graphite cathode to enhance the energy density of the electro-reduction process at the cathode, thereby resulting in a fuel cell having increased power.

Otherwise, the low cost of biological catalysts utilized in the anode chamber and the availability of carbohydrate feedstocks make microbial fuel cells an attractive technology for off-grid rural or remote power applications in developing countries.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is a conceptual illustration of an exemplary arrangement of a cathode-membrane assembly of the microbial fuel cell apparatus;

FIG. 2 is a conceptual illustration of an exemplary arrangement of a cathode-membrane assembly integrated with an anode assembly; and

FIG. 3 is a conceptual illustration of an exemplary cathode-membrane assembly and anode assembly integrated with peripheral hardware components.

### DETAILED DESCRIPTION

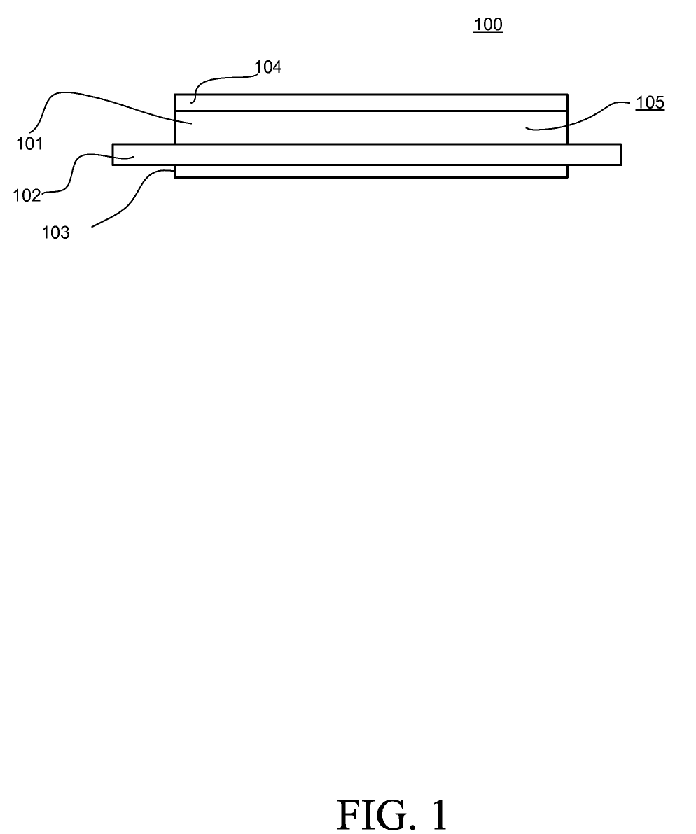

FIG. 1 is a conceptual illustration of an exemplary arrangement of a cathode-membrane assembly 100 of the microbial fuel cell apparatus. Cathode electrode 101 may be composed of carbon, such as a graphite fabric or other forms of carbon such as activated carbon, carbon powder, carbon cloth, carbon felt, carbon particles or carbon nanotubes. The porosity of cathode electrode 101 may range from about 1% to 80% of the structure. A solid oxide catalyst 105 may be interspersed generally uniformly within the cathode. The solid oxide catalyst may be mixed to form a porous composite structure composed of an electronic material such as carbon, graphite, Pt, Au to allow ease of electron transfer in and out of the oxide cathode catalyst. The particle size of the cathode oxide catalyst may range from 1 nm to 1000 micrometers. The solid oxide catalyst may also comprise a thin film coating on cathode electrode 101, ranging in thickness from 1 nm to 1000 micrometers generally.

Examples of solid oxide catalysts which may be suitable for cathode 101 of the microbial fuel cell include materials such as the family of perovskites with ABO_{3-d} composition such as SmₓSr_{y}CoO_{3-d}, BaₓLa_{y}CoO_{3-d}, GdₓSr_{y}CoO_{3-d}, Sr-doped Lanthanide transition metal oxides such as Ln₁₋ₓSrₓ(TM)O_{3-d} where Ln=Ba, La, Ca, Sm and TM=Cr, Mn, Fe, Co, Ni, or mixtures of these. Other cathode catalysts may comprise similar Sr-doped perovskites with two TM elements at the b-site such as, for example, La₁₋ₓSrₓ(Co_{1-y}Fe_{y})O_{3-d} or Ba₁₋ₓSrₓ(Co_{1-y}Fe_{y})O_{3-d}. Other transition metal oxides with the A₂BO_{4-d} composition such as LnSr(TM)O_{4-d} where Ln=Ba, La, Ca, Sm and TM=Cr, Mn, Fe, Co, Ni, Cu, Ru.

Electron collector medium 104 is in physical contact with cathode 101 to collect charge therefrom, and may be composed of a steel mesh material or other electronic conducting material, or a gas diffusion electrode.

Anion exchange membrane 102 may be any anion conducting material such as Selemion anion membrane from Asahi Glass Co. Ltd. of Japan, Neosepta anion membrane from Tokuyama Soda Co. Ltd. of Japan, Morgane anion membrane from Solvay SA of Belgium and other similar anion conducting membranes used in chemical separation, alkaline fuel cells and desalination systems. Other materials used may be aqueous-based, such as water and KOH solution, or composite mixtures of ion exchange/inert backbone material.

A retaining layer 103, composed for example of a plastic net material, may be optionally used to complete the cathode-membrane assembly 100 by keeping the cathode-membrane assembly 100 components compactly together.

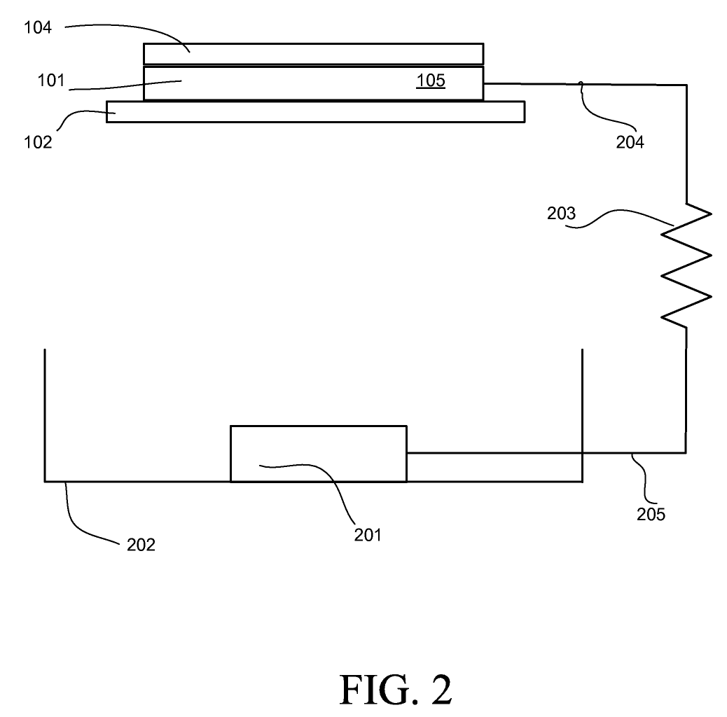

FIG. 2 is a conceptual illustration of an exemplary arrangement of a cathode-membrane assembly 100 integrated with an anode assembly. The anode electrode 201 is typically composed of carbon, such as of a porous carbon foam material, carbon cloth, carbon felt, carbon particles, activated carbon, carbon nanotubes, such as of a porous carbon foam material that maximizes its surface area. Anode 201 resides in a chamber 202 which is filled with an aqueous-based electrolyte medium, and anode 201 is receptive to electrons developed from a reaction of bacterial anode enzyme with organic nutrient in chamber 202. The organic fuel that can be utilized in the microbial fuel cell can be composed of any organic matter that comprises hydrogen and oxygen or carbon. Examples of this would be cellulose, ethanol, acetate, alcohols, human waste, agricultural waste, starch, farm animal waste, and industrial organics waste.

The bacterial anode enzyme utilized in the microbial fuel cell can be composed of a singular organism or a community culture that metabolizes the organic fuel and converts this into lower molecular weight organics such as alcohols with evolution of by products such as CO2 gas, CH4 gas, protons and electrons.

For single organism cultures, examples such as the Genus Clostridium, such as Clostridium cellulovorans, Clostridium celluliticum, that digest cellulose directly would be utilized to produce protons and electrons for reaction in the MFC and electrons to power the external load.

For community cultures, mixtures that contain bacteria such as E. Coli, Genus Clostridium, Genus Rhodoferax such as Rhodoferax Ferireducens, Geobacter metallireducens to breakdown cellulose and its sub-units to produce protons for reaction in the microbial fuel cell and electrons to flow around a complete electrical circuit. Resistive load 203 provides an electrical coupling from anode 201 to electron collector medium 104 at cathode 101. Resistive load 203 may also be directly coupled to cathode 101, alternatively.

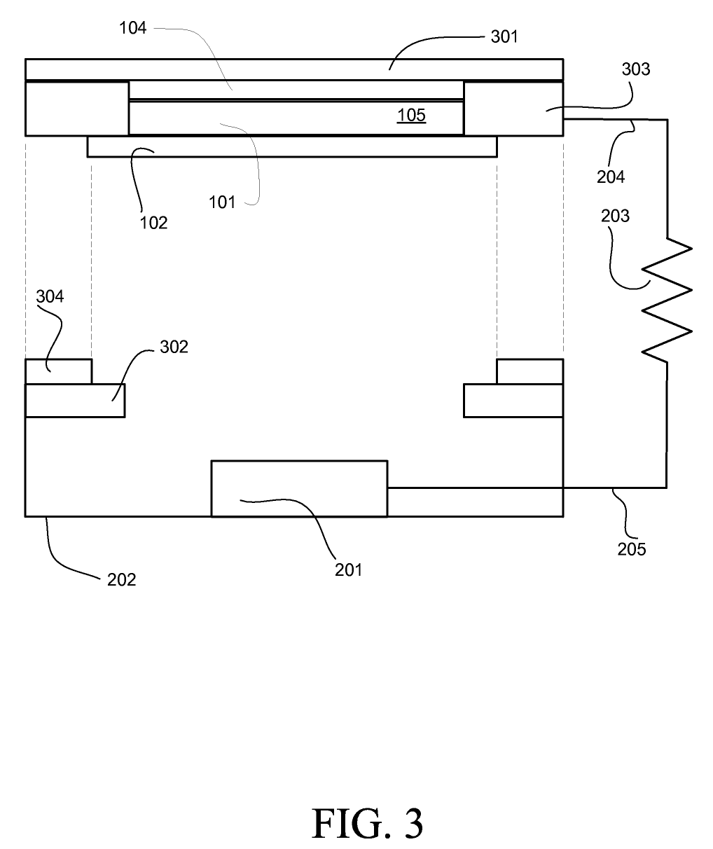

FIG. 3 is a conceptual illustration of an exemplary cathode-membrane assembly 100 and anode assembly integrated with peripheral hardware components. Lid 301 and sealing gasket 303 provide the means to secure the cathode-membrane assembly 100 to chamber 202. Lid 301 may be of plastic material, such as acrylic, and of slotted construction to allow availability of oxygen from the air for the electro-reduction process at cathode 101. The complete cathode-membrane assembly 100 disposed on lid 301 may be affixed onto chamber 202 by use of a suitable quick-release locking mechanisms, such as thumbscrews. This would allow easy access to chamber 202 for replenishing the organic fuel and bacterial enzyme mixture.

Sealing gasket 304 may be disposed on rim 302 of chamber 202, to enable the cathode-membrane assembly 100 to be compressively sealed against chamber 202. In this way, it would also be possible to aerobically seal chamber 202, to allow bacterial enzyme in chamber 202 to undergo anaerobic respiration in aid of the electro-oxidation process at anode 201.

Another embodiment of the invention provides a method of generating electrical power for an electrical charging device, such as for powering a cell phone charger. In this case, electrical power generated by operation of the microbial fuel cell is used to power a cell phone charger device, represented by resistive load 203. The electrical coupling may be adapted to include leads 204 and 205 from the cathode and anode respectively with suitable commercial terminations to enable easy and rapid plug-in or connection to the electrical charging device.

Another embodiment of the invention provides a method of generating electrical power for direct use in operating a light emitting device such as a bulb or LED. This can also be used to directly operate a radio and other electronic appliances, represented by resistive load 203.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. An apparatus for a microbial fuel cell comprising:
a chamber,
an anode disposed within the chamber, the anode being receptive to electrons developed from a reaction of bacterial anode enzyme with organic nutrient,
a cathode-membrane assembly comprising:
a cathode,
a solid oxide catalyst generally uniformly dispersed on the cathode,
an electron collector medium substantively in contact and electrically coupled with the cathode, and
an anion exchange membrane for passage of anions from the chamber to the cathode therethrough; and
an electrical coupling for coupling the anode to the cathode;
wherein the anion exchange membrane of the cathode-membrane assembly is disposed against the chamber.

2. The apparatus for a microbial fuel cell of claim 1 wherein the cathode comprises a carbon-based material.

3. The apparatus for a microbial fuel cell of claim 1 wherein the solid oxide catalyst comprises a film of thickness ranging from 1 nm to 1000 micrometers disposed on the cathode

4. The apparatus for a microbial fuel cell of claim 3 wherein the solid oxide catalyst is at least one of a perovskite having a composition of the form ABO_{3-d} or A₂BO_{4-d} or a lanthanide transition metal oxide.

5. The apparatus for a microbial fuel cell of claim 4 wherein the solid oxide catalyst comprises a particle size ranging from 1 nm to 1000 micrometers.

6. The apparatus for a microbial fuel cell of claim 1 wherein the cathode comprises a porosity ranging from 1% to 80% by volume.

7. The apparatus for a microbial fuel cell of claim 1 wherein the anode comprises a carbon-based material.

8. The apparatus for a microbial fuel cell of claim 1 wherein the bacterial anode enzyme comprises at least one of E. Coli, Genus Clostridium, or Genus Rhodoferax organisms.

9. The apparatus for a microbial fuel cell of claim 1 wherein the chamber is aerobically sealed.

10. The apparatus for a microbial fuel cell of claim 1 wherein the electron collector medium is an electronic conducting material or a gas diffusion electrode.

11. The apparatus for a microbial fuel cell of claim 1 wherein the electrical coupling for coupling the anode to the electron collector medium further comprises a resistive load.

12. An apparatus for a microbial fuel cell comprising:
a chamber,
an anode disposed within the chamber, the anode being receptive to electrons developed from a reaction of bacterial anode enzyme with organic nutrient, the anode further being receptive to anions developed from an aqueous-based electrolyte within the chamber,
a cathode assembly comprising:
a cathode,
a solid oxide catalyst generally uniformly dispersed on the cathode, and
an electron collector medium substantively in contact and electrically coupled with the cathode; and
an electrical coupling for coupling the anode to the cathode;
wherein the anion exchange membrane of the cathode-membrane assembly is disposed against the chamber.

13. A method of generating electrical power in a microbial fuel cell, the method comprising:
electro-oxidizing an organic nutrient on an anode in the presence of a bacterial anode enzyme;
electro-reducing a cathode oxidant on a cathode, spatially separate from the anode, in the presence of a solid oxide catalyst; and
electrically coupling the anode to the cathode via a resistive load to enable transfer of electrons thereto.

14. The apparatus for a microbial fuel cell of claim 13 wherein the cathode comprises a porosity ranging from 1% to 80% by volume.

15. The method of generating electrical power of claim 13 wherein the solid oxide catalyst is at least one of a perovskite having a composition of the form ABO_{3-d} or A₂BO_{4-d} or a lanthanide transition metal oxide.

16. The method of generating electrical power of claim 13 wherein the solid oxide catalyst comprises a particle size or film thickness ranging from 1 nm to 1000 micrometers.

17. An electrical charging device for charging an electrically-operated device comprising:
a chamber,
an anode disposed within the chamber, the anode being receptive to electrons developed from a reaction of bacterial anode enzyme with organic nutrient,
a cathode-membrane assembly comprising:
a cathode,
a solid oxide catalyst generally uniformly dispersed on the cathode,
an electron collector medium substantively in contact with the cathode, and
an anion exchange membrane for passage of anions from the anode to the cathode therethrough; and
first and second leads from the anode and the electron collector medium respectively for coupling to the electrically-operated device and providing electrical power thereto;
wherein the anion exchange membrane of the cathode-membrane assembly is disposed against the chamber.

18. The electrical charging device of claim 17 wherein the cathode comprises a porosity ranging from 1% to 80% by volume.

19. The electrical charging device of claim 17 wherein the solid oxide catalyst is at least one of a perovskite having a composition of the form ABO_{3-d} or A₂BO_{4-d} or a lanthanide transition metal oxide.

20. The electrical charging device of claim 17 wherein the solid oxide catalyst comprises a particle size or film thickness ranging from 1 nm to 1000 micrometers.
